(19) United States
(12) Patent Application Publication
(10) Pub. No.: US 2014/0308330 A1
(43) Pub. Date: Oct. 16, 2014

(54) CORE-SHELL QUATERNARY AMMONIUM NANOMATERIALS, METHODS AND APPLICATIONS

(71) Applicant: UNIVERSITY OF CENTRAL FLORIDA RESEARCH FOUNDATION, INC., Orlando, FL (US)

(72) Inventors: Swadeshmukul Santra, Orlando, FL (US); Joshua Bazata, Winter Springs, FL (US); Mikaeel Young, Oviedo, FL (US)

(73) Assignee: UNIVERSITY OF CENTRAL FLORIDA RESEARCH FOUNDATION, INC., Orlando, FL (US)

(21) Appl. No.: 14/248,725

(22) Filed: Apr. 9, 2014

Related U.S. Application Data
(60) Provisional application No. 61/810,360, filed on Apr. 10, 2013.

(51) Int. Cl. A01N 33/12; B01D 53/34

(52) U.S. Cl. CPC A01N 33/12; B01D 53/34
USPC 424/421; 252/183.13; 423/210; 514/63

(57) ABSTRACT

Quaternary ammonium materials may be immobilized onto a metal oxide nanoparticle to provide a fixed-quat nanoparticle material. A particular example uses a silicon alkoxide as a silicon source material to provide a fixed-quat SiNP/NG material composition through either acidic or basic hydrolysis of the silicon alkoxide material. Particular materials may be characterized spectroscopically to ensure that the desirable materials are properly bound. Specific applications of fixed-quat SiNP/NC material compositions in accordance with the embodiments include, but are not limited to agricultural biocide applications and tobacco smoke selective filtration applications.

### CROSS-REFERENCE TO RELATED APPLICATION

This application is related to, and derives priority from, U.S. Provisional Patent Application Ser. No. 61/810,360, filed 10 Apr. 2013 and titled Tobacco Smoke Filtration Device and Method, the contents of which are incorporated herein fully by reference.

### BACKGROUND

1. Field of the Invention

Embodiments relate generally to quaternary ammonium nanomaterials. More particularly embodiments relate to agricultural applications and consumer product applications of quaternary ammonium nanomaterials.

2. Description of the Related Art

Citrus canker is a devastating citrus disease that infects citrus fruit, stem, twig and leaf surfaces, and is caused by the bacterium Xanthomonas. The severity of infection is reflected through premature fruit drop, defoliation, shoot die-back and appearance of blemishes on fruit surfaces. Spread of citrus canker has been confirmed in over thirty countries, including the United States, and has destroyed over 16 million trees in the state of Florida, seriously affecting the multi-billion dollar citrus industry. Short-distance transmission of citrus canker bacteria from infected trees to surrounding unaffected trees is primarily caused by wind and rain. However, long-distance canker infections can occur as a result of severe weather conditions, specifically during tropical storms, hurricanes and tornadoes.

Citrus canker is currently managed and controlled through topical application of copper compounds, which unfortunately bio-accumulate.

Since citrus canker is such a pervasive agricultural affliction with significant economic impact, desirable are environmentally friendly methods and materials that may effectively manage or control citrus canker.

### SUMMARY

Embodiments provide: (1a) a metal oxide immobilized quaternary ammonium nanomaterial (i.e., a “fixed-quat” nanomaterial); (1b) a method for preparing the metal oxide immobilized quaternary ammonium nanomaterial; (2) a biocide and a related agricultural method that use the metal oxide immobilized quaternary ammonium nanomaterial; and finally (3) a filter and a filtration method that use the metal oxide immobilized quaternary ammonium nanomaterial.

More particularly within the context of agricultural applications, the embodiments provide fixed-quat nanomaterials technology as an alternative to Cu based fungicides, microbicides and bactericides for managing or controlling citrus canker. The proposed fixed-quat nanomaterials in accordance with the embodiments integrate at minimum the powerful antimicrobial, antibacterial and antifungal (i.e., intended in an aggregate as biocidal, and in particular topical biocidal) properties of quaternary ammonium (i.e., “quat”) compounds into a silica nanoparticle/nanogel (SiNP/NG) based delivery system. The proposed fixed-quat nanomaterials technology has the ability to attenuate quat phytotoxicity while maintaining superior biocidal properties. A fixed-quat nanomaterial in accordance with the embodiments is anticipated to be environmentally-friendly insofar as quat is bound to a SiNP/NG material.

Beyond the foregoing application with respect to citrus canker an outcome of the investigations reported herein has potentially high impact as fixed-quat material could potentially be widely used as an agricultural biocide to address many other agricultural microbial infections, bacterial infections and fungal infections, such as but not limited to Xanthomonas axonopodis pv citri, Xylella fastidiosa, Candidatus Liberibacter spp, Staphylococcus aureus, Pseudomonas aeruginosa, Pseudomonas syringae and Escherichia coli microbial infections, bacterial infections and fungal infections. Applicability to specific types of these additional microbial infections, bacterial infections and fungal infections may be readily determined by a person of ordinary skill in the art while using evaluation techniques described in greater detail below.

In addition to the foregoing agricultural biocide applications of fixed-quat nanomaterials the embodiments also contemplate a consumer product application or industrial product application of fixed-quat materials within the context of selective filtration of a multicomponent aerosol, such as but not limited to a tobacco smoke aerosol. In particular with respect to a tobacco smoke aerosol, the embodiments contemplate tobacco smoke aerosol filtration and purification in a fashion which is specific to a carcinogen material component removal from within a tobacco smoke aerosol while being relatively and comparatively transparent to a nicotine component removal within the tobacco smoke aerosol. Such elective and selective aerosol or smoke filtration is predicated upon chemical differences within aerosol or smoke components which may be used to engineer relevant complementary and correlating chemical differences within fixed-quat nanomaterials in accordance with the embodiments, absent undue experimentation by a person of ordinary skill in the art.

A particular nanomaterial in accordance with the embodiments includes a nanoparticle comprising a metal oxide immobilized quaternary ammonium material.

A particular method for preparing a nanomaterial in accordance with the embodiments includes hydrolyzing a metal oxide precursor material within the presence of a quaternary ammonium material to provide a nanoparticle comprising a metal oxide immobilized quaternary ammonium material.

A particular biocide in accordance with the embodiments includes: (1) a nanomaterial comprising a nanoparticle comprising a metal oxide immobilized quaternary ammonium material; and (2) a carrier fluid.

A particular agricultural method in accordance with the embodiments includes treating with a nanoparticle based biocide comprising a metal oxide immobilized quaternary ammonium material an agricultural crop susceptible to a detrimental biologic infection.

A particular filter in accordance with the embodiments includes a nanomaterial comprising a nanoparticle comprising a metal oxide immobilized quaternary ammonium material.

A particular aerosol filtration method in accordance with the embodiments includes filtering with a nanoparticle based filtration medium comprising a metal oxide immobilized quaternary ammonium material an aerosol stream to preferentially capture from the aerosol stream a first aerosol component with respect to a second aerosol component different from the first aerosol component.

### BRIEF DESCRIPTION OF THE DRAWINGS

The objects features and advantages of the embodiments are understood within the context of the Detailed Description of the Non-Limiting Embodiments, as set forth below. The Detailed Description of the Non-Limiting Embodiments is understood within the context of the accompanying drawings, which form a material part of this application, wherein:

FIG. 1 shows a schematic diagram of a fixed-quat SiNP/NG nanomaterial composite nanoparticle showing in outward progression a hydrophilic core (porous), a charge neutralized core surface intermediate layer and a hydrophobic shell.

FIG. 2 shows a schematic diagram illustrating a fixed-quat SiNP/NG design and synthesis strategy in accordance with the embodiments.

FIG. 3 shows a project flow diagram illustrating structural aspects of fixed-quat SiNP/NG investigations in accordance with the embodiments.

FIG. 4 shows a representative FE-SEM image of fixed-quat SiNP/NG nanomaterial nanoparticles in accordance with the embodiments, showing fairly uniform size (monodispersed) nanoparticles with average size of about 230 nm.

FIG. 5 shows a representative FE-SEM image of fixed-quat SiNP/NG (DDAC) nanomaterial nanogel in accordance with the embodiments, showing a wide range of particle sizes ranging from less than 100 nm to over 1 micron. The film forming layers of the material can be seen at the edges.

FIG. 6 shows a representative FE-SEM image of fixed-quat SiNP/NG (TDBAC) nanomaterial nanogel in accordance with the embodiments, showing a wide range of particle sizes ranging from less than 100 nm to over 1 micron.

FIG. 7 shows an FT-IR spectra (i.e., in a KBr matrix) of: (1) quat (small dotted line); (2) SiNPs (medium dotted line); and fixed-quat SiNPs (big dotted line) (i.e., from top to bottom at inset and at 3100 cm⁻¹). Characteristic FT-IR peaks for quat were observed as shown in the inset, confirming successful quat immobilization into SiNPs. There is a complete shift in the —CH stretching frequencies of the quat —CH₂ group, which suggests that the chemical environment of quat has changed when immobilized into a SiNP.

FIG. 8 shows phytotoxicity (plant tissue injury) results obtained from formulations of fixed-quat sprayed on Vinca sp. In green-house conditions, approximately 5 mL of as synthesized formula was sprayed on plants at 7:30 am on the test day. All treatments were found to be non-phytotoxic at the 24 hr mark except the quat in water. After 72 hrs, all treatments were non-phytotoxic to plants except the quat in water. Extent of plant tissue injury grew more intense over time in quat treatment. (−) and (+) signs represent “non-phytotoxic” and “phytotoxic,” respectively. (++) sign represents “severely phytotoxic.”

FIG. 9 shows the results of a study of fixed-quat SiNP retention to leaf surfaces. Leaf surfaces were spray-coated with fixed-quat SiNP and then labeled with yellow-emitting Q dots followed by drying. Then approximately 5 mL of water was sprayed continuously for 5 minutes to simulate rainfall upon the leaf surfaces. Digital images were taken which showed Q dot fluorescence after washing, suggesting strong retention of the fixed-quat SiNP material to the leaf surface.

FIG. 10 shows the results of a fixed-quat SiNP/NG bacterial inhibition assay (turbidity measurements) conducted in broth. Antibacterial efficacy experiments were done with serially diluted test samples and compared with controls which included Kocide 3000 (positive) and SiNP (negative).

FIG. 11 shows the results of a fixed-quat SiNP/NG growth curve assay (turbidity measurements) of various fixed-quat silica materials conducted in broth and compared with controls which included Kocide 3000 (positive) and SiNP (negative).

FIG. 12 shows the results of a fixed-quat SiNP/NG bacterial viability assay colony forming units (CFU/mL) of various fixed-quat silica materials conducted on an agar plate and compared with controls which included Kocide 3000 (positive) and SiNP (negative).

FIG. 13 shows the results of a fixed-quat SiNP/NG alamar blue assay (absorbance measurements expressed in reduction of alamar blue) of various fixed-quat silica materials conducted in broth and compared with controls which included Kocide 3000 (positive) and SiNP (negative). Alamar blue is a colorimetric/fluorometric dye which indicates cell viability. Reduction of the dye related to growth causes the change from oxidized (non-fluorescent, blue) form to reduced (fluorescent, red) form.

FIG. 14 shows the results of experimental measurements with respect to tobacco smoke purification while using a fixed-quat SiNP/NG nanomaterial in accordance with the embodiments.

### DETAILED DESCRIPTION OF THE NON-LIMITING EMBODIMENTS

Embodiments provide a fixed-quat nanomaterial composition, a method for preparing the fixed-quat nanomaterial composition and related methods or components that use the fixed-quat nanomaterial composition within the context of agricultural applications and consumer or industrial product applications. The fixed-quat nanomaterial composition in accordance with the embodiments includes a quaternary ammonium material as a shell material immobilized with respect to a metal oxide based core material, such as but not limited to a silicon oxide based core material. The fixed-quat nanomaterial composition in accordance with the embodiments is particularly useful in managing and controlling citrus canker, and potentially other related microbial and bacterial agricultural afflictions within various agricultural crop applications. The fixed-quat nanomaterial composition may also be useful in selective filtration of aerosol components within a multicomponent aerosol, such as but not limited to a smoke aerosol.

### 1. General Considerations for Embodied Fixed-Quat Core-Shell Nanomaterial Compositions

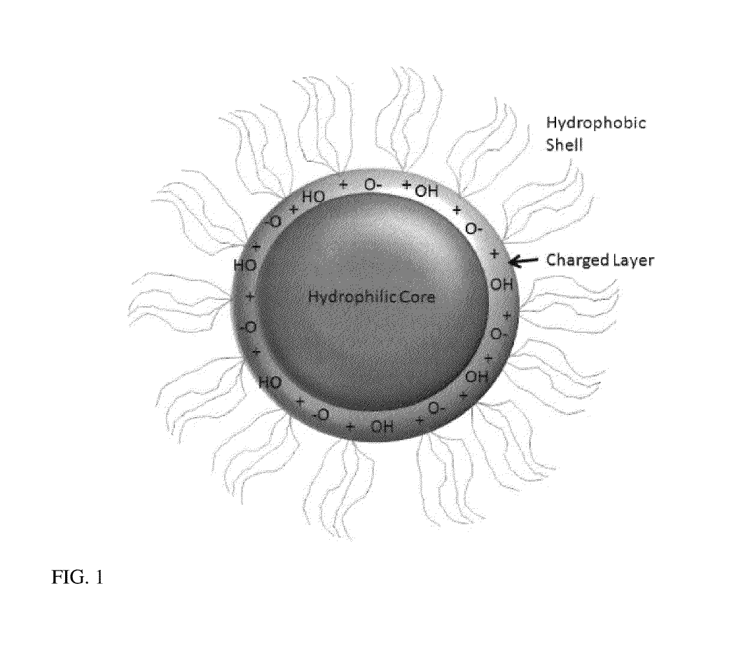

A generalized fixed-quat core-shell nanoparticle nanomaterial composition in accordance with the embodiments is illustrated in FIG. 1. As is illustrated in FIG. 1, the fixed-quat core-shell nanoparticle nanomaterial composition comprises a hydrophilic core which is porous and which also comprises a metal oxide material and more particularly a silicon oxide material. Surrounding the hydrophilic core is a charge neutralization layer which comprises negative hydroxyl surface charges from the hydrophilic core that are nominally neutralized with positive quaternary ammonium charges from the quaternary ammonium material that comprises the hydrophobic shell.

Within the embodiments the hydrophilic core comprises a metal oxide selected from the group including but not limited to silicon, titanium, aluminum, zinc and cerium metal oxides. Within the embodiments the hydrophilic core has a diameter from about 10 to about 500 nanometers. Within the embodiments the charge neutralization layer has a thickness from about 0.1 to about 2 nanometers. Within the embodiments the hydrophobic shell has a thickness from about 1 to about 50 nanometers and comprises tail groups from the quaternary ammonium nanomaterial that comprises the hydrophobic shell.

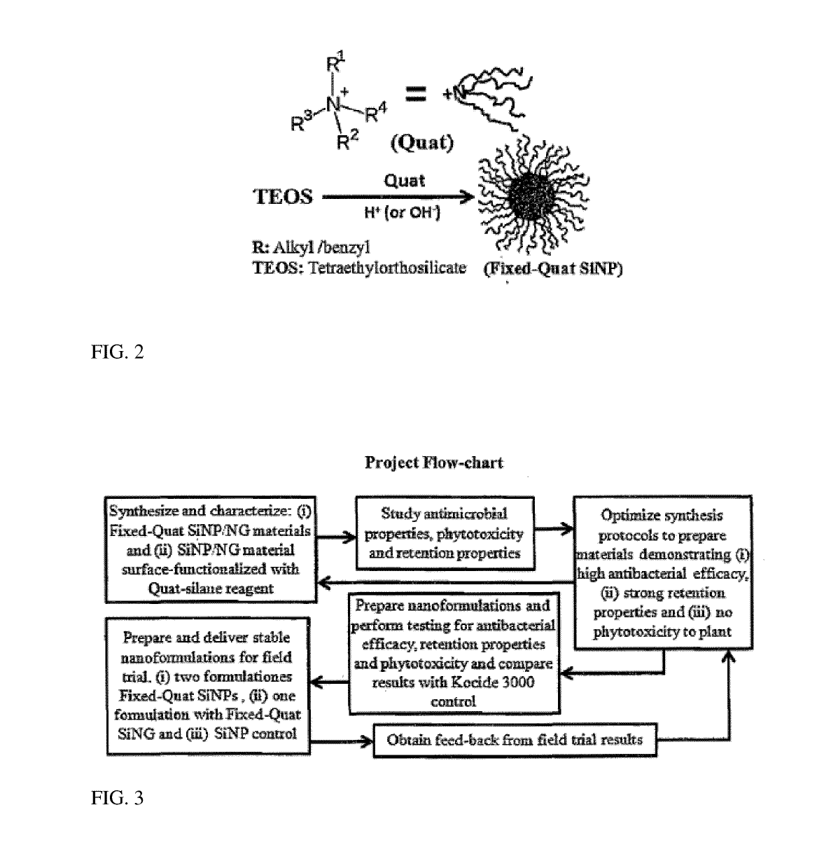

Within the embodiments the quaternary ammonium material that comprises the hydrophobic shell has a general chemical structure as illustrated in FIG. 2 where R1, R2, R3 and R4 may each independently comprise a hydrogen radical, a C1 to C20 alkyl radical, a C1 to C20 alkenyl radical, a C1 to C20 alkynyl radical or any type of aromatic radical. Longer chain alkyl radical groups are preferred but not necessarily required in a quaternary ammonium material compound in accordance with the embodiments. Various simple and complex anions are also contemplated within the context of a quaternary ammonium material.

The fixed-quat nanomaterials in accordance with the embodiments may be prepared using an alkoxide hydrolysis and condensation reaction that may be either acid catalyzed or base catalyzed as shown below within the context of additional embodiments. More particularly within the context of the embodiments, base catalyzed reactions are characterized as providing nanoparticle materials while acid catalyzed reactions are characterized as providing nanoglass (i.e., nanogel) materials.

Thus, in accordance with the foregoing, acid catalyzed fixed-quat nanomaterials preparation reactions in general produce ultrafine sol particles (i.e., less than about 10 nm diameter). These ultrafine sol particles form a gel-like network after further condensation process (sol-gel process). With respect to materials applications and performance characteristics, such a gel based material forms a uniform coating.

Also in accordance with the foregoing, base catalyzed fixed-quat nanomaterials preparation reactions in general produce fairly monodispersed (i.e., uniform size) particles which are individually stabilized (i.e., that form a stable colloidal suspension). With respect to materials applications and performance characteristics, such a particulate based material is usually moderately acceptable in forming films.

As a related issue in fixed-quat nanomaterials preparation reactions, quaternary ammonium salts are usually basic in nature. Thus, mixing a quaternary ammonium salt with only a silica precursor (i.e., such as but not limited to tetraethylorthosilicate or sodium silicate) can produce a fixed-quat SiNP core-shell nanomaterial composite in absence of any catalyst.

### 2. Specific Considerations for Agricultural Applications of the Embodiments

One thrust of the research in accordance with the embodiments is intended to provide a robust alternative solution to Cu based fungicides and bactericides for preventing endemic citrus canker disease. Success of this research will benefit citrus growers worldwide by reducing dependency on Cu compounds for citrus canker management and control. The proposed technology in accordance with the embodiments has the ability to drastically minimize quat phytotoxicity while maintaining biocidal (i.e., antimicrobial and antibacterial) properties to a level that is desired for citrus canker prevention. However, successful implementation of this technology will require optimization of fixed-quat material synthesis protocols, producing stable nanoformulations with optimal efficacy for field trials.

2.A. Motivation for Selecting Fixed-Quat Materials for Agricultural Applications

The basic premise of the embodiments is to electrostatically capture and immobilize quat biocidal compounds in a silica matrix during a growth process of SiNP/NG materials during an in-situ synthesis. Quat compounds belong to a class of cationic surfactants consisting of a positively charged quaternary ammonium (“head”) group and hydrophobic alkyl (“tail”) groups. SiNP/NG is a negatively charged material with high surface area to volume ratio. Therefore, quat molecules are electrostatically captured and surface-immobilized to the SiNP/NG materials as illustrated in FIG. 2. Fixed-quat SiNP/NG material is expected to be environmentally friendly due to the low possibility of the quat molecule being released from the nanomaterial into the environment.

2.B. Advantages of the Proposed Fixed-Quat SiNP/NG Preparation Method

The proposed in-situ synthesis strategy for capturing quat on to SiNP/NG materials is simple and efficient. Two other strategies for preparing quat-SiNP/NG materials are: (i) surface functionalization of SiNP/NG material with a quat-silane compound (e.g. dimethyltetradecyl-[3-(trimethoxysilyl)-propyl] ammonium chloride); and (ii) mixing of quat with SiNP/NG material. Table 1 summarizes the advantages and limitations of the proposed fixed-quat SiNP/NG preparation strategy with the other two strategies and compares their anticipated material properties. FIG. 3 illustrates a generalized project flow in accordance with the embodiments.

TABLE I

| | Quat-SiNP/NG preparation strategies | | |
|---|---|---|---|
| | Proposed in-situ | Synthesis of SiNP/NG | |
| | synthesis of Fixed- | material surface- | |
| Advantages/ | Quat SiNP/NG | functionalized with | SiNP/NG material |
| Limitations | material | Quat-silane | mixed with Quat |
| Quat immobilization | Electrostatic | Covalent | Electrostatic |
| Quat loading | High | Moderate | Low |
| efficiency | | | |
| Versatility | Accept all kinds of | Accept only Quat- | Accept all kinds of |
| | Quat compounds | silane compounds | Quat compounds |
| | | (limited availability) | |
| Quat Raw materials | Low | High | Low |
| cost | | | |
| Chances of Quat | Low | Negligible | High |
| release from the | | | |
| materials | | | |
| Phytotoxicity | Low | High | High |
| Anticipated | Moderate to high | Moderate | Low to moderate |
| Antimicrobial | | | |
| efficacy | | | |
| Anticipated colloidal | Moderate to high | Low | Low |
| stability in aqueous | (through formation of | | |
| solution | Quat double layer) | | |
| Retention | High | Moderate to high | Low to moderate |
| (adherence) to plant | | | |
| surface | | | |

### 3. Experimental

3.A. General Considerations

Preliminary research data supports the hypothesis that fixed-quat SiNP/NG nanomaterial is non-phytotoxic and exhibits efficient anti-bacterial properties and retention properties. Fixed-quat SiNP/NG nanomaterial was synthesized as follows. Briefly, sol-gel hydrolysis and condensation reaction of tetraethylorthosilicate (TEOS) was done under basic conditions in the presence of quat (Quat Disinfectant Cleaner Solution—5H, supplied by 3M Company, St. Paul, Minn.). Active ingredients within the 5H cleaner composition included: (1) octyl decyl dimethyl ammonium chloride=6.510%; (2) dioctyl dimethyl ammonium chloride=2.604%; (3) didecyl dimethyl ammonium chloride=3.906%; and (4) alkyl (C14 50%, C12 40%, C16 10%) dimethyl benzyl ammonium chloride=8.680%. Particle size was controlled by adjusting the time of quat addition to the basic reaction mixture containing TEOS. Particle size was characterized using field emission scanning electron microscopy (FE-SEM).

Another fixed-quat SiNP/NC synthesis method was acid catalyzed tetraethylorthosilicate (TEOS) hydrolysis in the presence of quat materials such as but not limited to: (1) dimethyl didecyl ammonium chloride (DDAC) (CAS 7173-51-5, U.S. EPA PC code 069149, 769149, EPA Registered); (2) tetradecyl dimethyl benzyl ammonium chloride (TDBAC) (CAS 139-08-2, U.S. EPA PC code 069107, EPA Registered); and (3) dimethyltetradecyl[3-(trimethoxysilyl)propyl]ammonium chloride (DTD-3-TSPAC) (CAS 41591-87-1, U.S. EPA PC code 107409, EPA Registered). As indicated above, such an acid catalyzed synthesis produced a nanogel material.

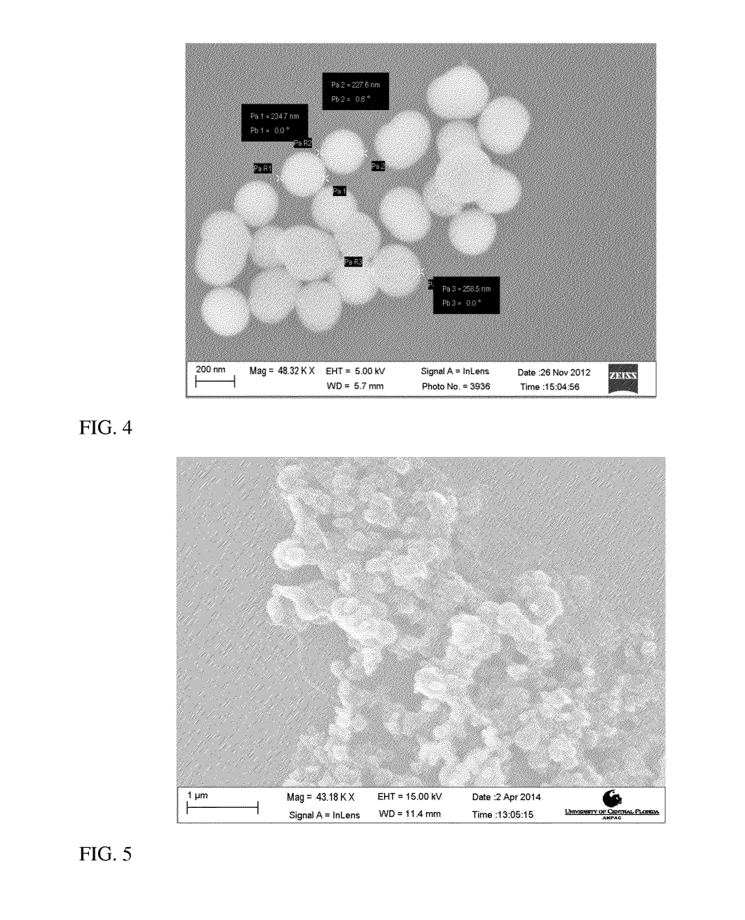

FIG. 4 shows particle size and size distribution of fixed-quat SiNPs synthesized with quat added at 30 minutes. At zero minute fixed-quat SiNPs were polydispersed (particle size range 100-300 nanometers; figure not shown). However at 15 mins fixed-quat SiNPs were fairly monodispersed and the particle size was similar to 30 min fixed-quat SiNPs. It is suggested that nucleation and growth of silica nanoparticle were affected by the quat at zero min.

FIG. 5 shows particle size and size distribution of fixed-quat SiNG (DDAC) prepared through acid hydrolysis. Particle sizes varied from less than 100 nm to over 1 micron. Particles were layered indicating a film forming capability of the material.

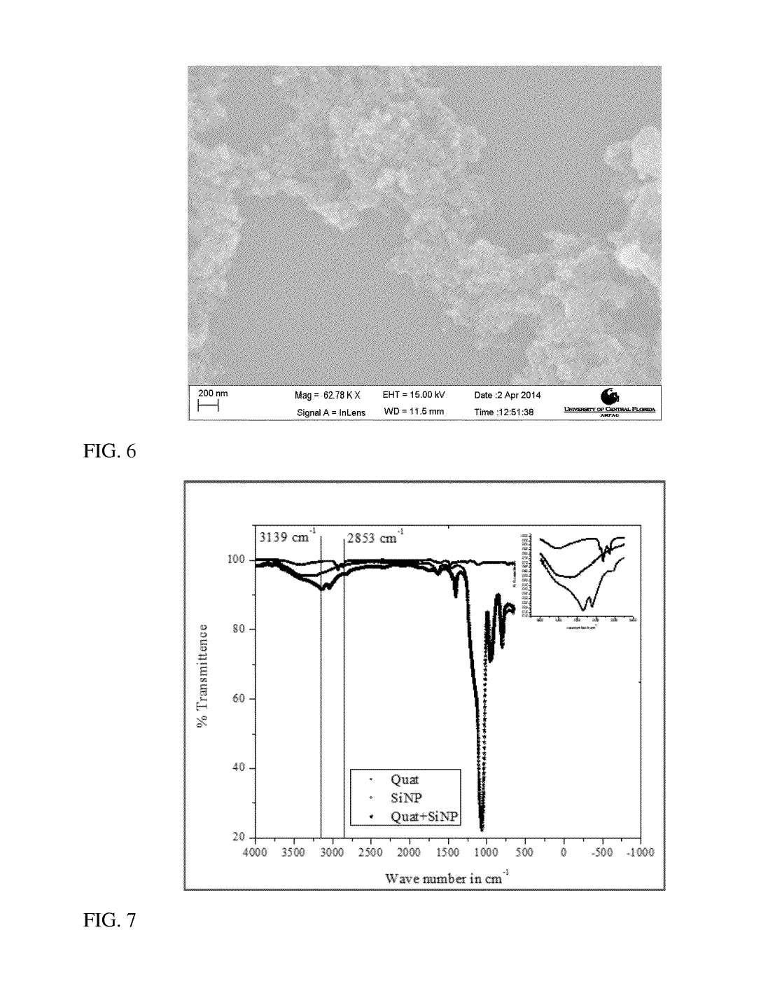

FIG. 6 shows particle size and size distribution of fixed-quat SiNG (TDBAC) prepared through acid hydrolysis. Particle sizes varied from less than 100 nm to over 1 micron.

Fourier transform infrared spectroscopy (FTIR) studies were obtained to confirm quat immobilization to the SiNPs. FIG. 7 shows FT-IR. spectra of (i) quat (in KBr matrix), (ii) SiNPs, and (iii) fixed-quat SiNPs. Characteristic FT-IR peaks for quat were observed as shown in the inset of FIG. 7, confirming successful quat immobilization to SiNPs. Within the embodiments a complete extinction of a quat unbound resonance and replacement with an additional resonance indicative of immobilization of the quat material is desirable insofar as such spectral characteristics are indicative of absence of free leachable quat material. While this particular embodiment illustrates this characteristic within the context of FTIR spectroscopy resonances, the embodiments are similarly also not so limited. Rather, the embodiments may utilize any spectroscopic method that serves as a marker for a free state and an immobilized state of a quat material. Such spectroscopic methods may include, but are not limited to FTIR, Raman, NMR and several other spectroscopic techniques.

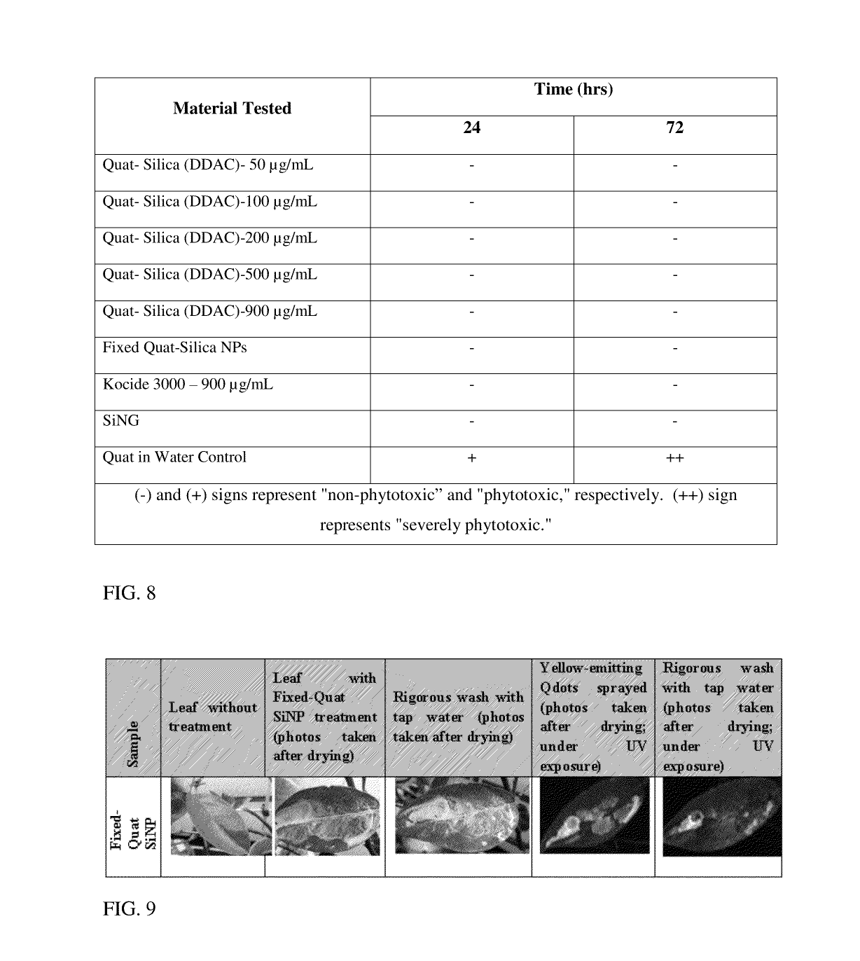

Phytotoxicity studies were carried out using vinca (an ornamental plant, highly susceptible to phytotoxicity; purchased from Home Depot). Three water based formulations at neutral pH were prepared using fixed-quat SiNPs synthesized by adding quat at three different times (0 min, 15 min, and 30 min). Quat (dissolved in water) was used as the positive control and SiNP and Kocide 3000 (dispersed in water) were used as negative controls. FIG. 8 shows phytotoxicity results at 24 and 72 hrs after plants were treated. Quat control exhibited phytotoxicity within 24 hrs while all other treatments remained non-phytotoxic even after 72 hours.

The retention properties of the fixed-quat SiNPs were tested using an inorganic semiconductor based fluorescent label (yellow-emitting hydrophobically modified quantum dots of 3.5 nm size Q dots). SiNPs were labeled with Q dots (through hydrophobic interaction) prior to spray applications. A procedure is briefly discussed as follows. Fixed-quat SiNP was spray-applied to the surface of a citrus leaf (Hamlin Orange, purchased from Home depot) until the formula began to drip. After an hour, the dried fixed-quat SiNP deposits were labeled with Q dots. The citrus leaf was then vigorously sprayed with water continuously for 5 min to simulate rainfall conditions. After one hour, the leaf was exposed to a hand-held UV lamp to observe Q dot fluorescence. FIG. 9 shows digital images of the leaf before and after the spray. Fluorescence was only observed from the deposits and not from other parts of the leaf surface. This supports the observation that the fixed-quat SiNP has strong retention properties.

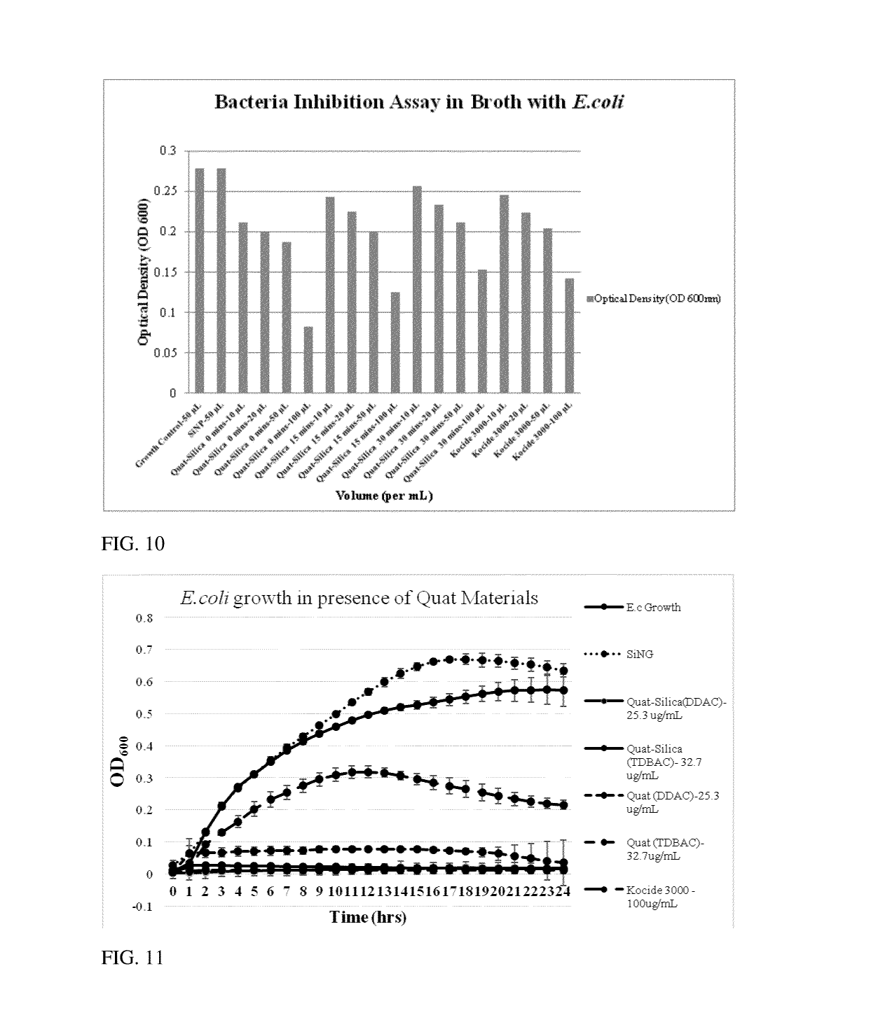

Antibacterial studies (growth inhibition in LB broth) were done using E. coli bacteria (ATCC 35218) for fixed-quat SiNPs of three different formulations (as described above). Bacterial growth was determined by measuring turbidity (optical density) in broth. Test samples were serially diluted and compared with controls, Kocide 3000 (positive) and SiNP (negative). Stock solutions of 100 μL, 200 μL, 500 μL and 1000 μL were added to tubes containing 8 mL of LB broth respectively containing varying amounts of DI H₂O, bringing the total volume to 10 mL. The concentrations of formulas were then 10 μL, 20 μL, 50 μL and 100 μL per mL in each tube. The fixed-quat SiNP 0 mins formula shows the most efficacy compared to the other fixed-quat SiNP formulations and the Kocide 3000 control. The Kocide 3000 control was made to contain a metallic copper content comparable to the copper silica nanogel. FIG. 10 shows that bacterial growth inhibition increased with increasing formula concentration. The fixed-quat SiNPs at 0 min showed the highest efficacy in comparison to the formula at 15 and 30 mins, suggesting improved quat immobilization. As expected, SiNP did not inhibit bacterial growth whereas Kocide 3000 (at recommended field trial dosage of 1.0 lb/acre) showed moderate efficacy. All the fixed-quat SiNP formulations showed comparable efficacy to Kocide 3000 and they were all non-phytotoxic. Therefore, preliminary results strongly support the feasibility of developing a non-Cu based biocide (i.e., microbicide/bactericide/fungicide) for long term protection against citrus canker and other afflictions.

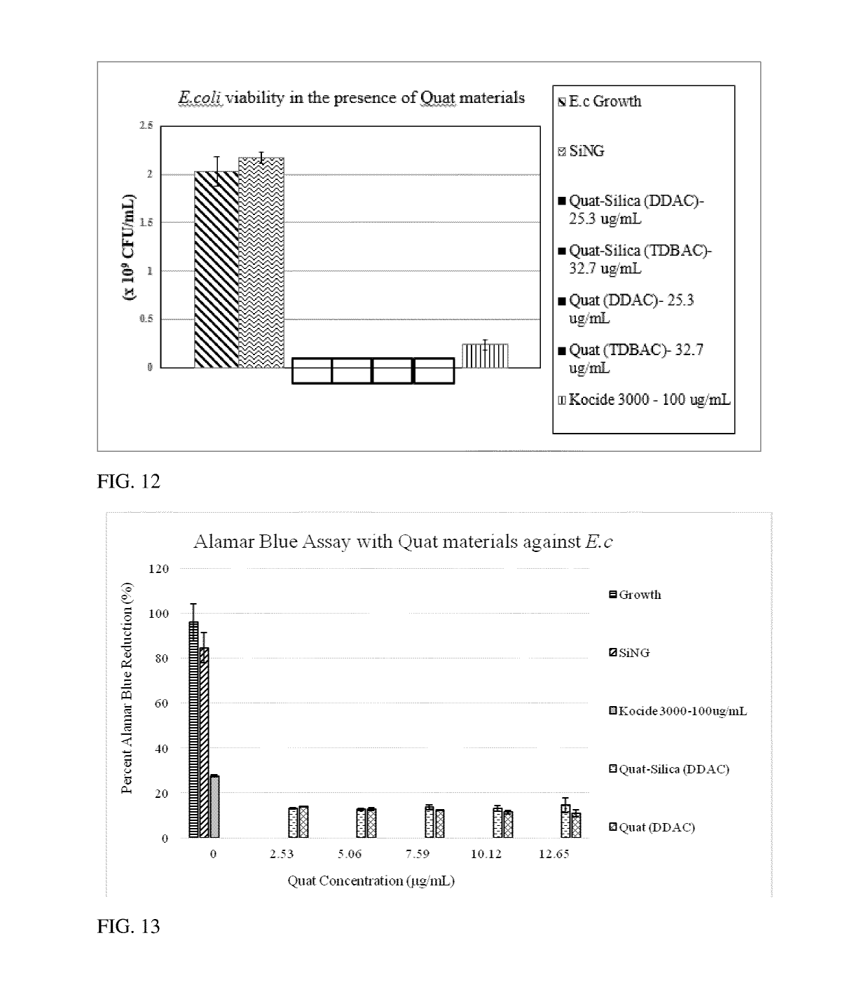

Antimicrobial studies conducted on acid catalyzed fixed-quat SiNG (DDAC and TDBAC) nanomaterials included: (1) growth curves (i.e., as illustrated in FIG. 11); (2) bacterial viability with CFU/mL (i.e., as illustrated in FIG. 12); and (3) alamar blue assay (i.e., as illustrated in FIG. 13).

Growth curves were determined by measuring turbidity (i.e., optical density) in a broth formulation over a 24 hr period. Test samples were added to wells in a 96-well plate and compared with controls, Kocide 3000 (positive) and SiNP (negative). Stock solutions of 5 μL were added to wells with 20 μL H₂O and 175 μL bacteria/LB broth. The concentrations of formulas were determined to be 25.3 μg/mL for DDAC materials and 32.7 μg/mL for TDBAC materials. The DDAC and TDBAC materials showed high efficacy over the Kocide 3000 control. The Kocide 3000 control was prepared to contain a metallic copper content of 100 μg/mL. FIG. 11 shows that bacterial growth inhibition increased with increasing formula concentration.

Bacterial viability studies with colony forming unit (CFU/mL) determinations were made for DDAC and TDBAC fixed-quat SiNG nanomaterials against E. coli. Materials were incubated for 24 hrs in LB broth and then serially diluted with phosphate buffered saline (PBS) before being plated on LB agar. Colonies were counted within 16-20 hrs after plating. DDAC concentration used was 25.3 μg/mL, while TDBAC was 32.7 μg/mL and Kocide 3000 had a metallic Cu concentration of 100 μg/mL. FIG. 12 shows bacteria were completed killed at the concentrations of fixed-quat SiNG materials while viability was only reduced in Kocide 3000 but not completely killed.

The alamar blue assay was used to test how low the fixed-quat SiNG (DDAC) nanomaterial concentration can be applied while maintaining effectiveness. Test samples were added to wells in a 96-well plate and compared with controls, Kocide 3000 (positive) and SiNP (negative). A series of fixed-quat (DDAC) concentrations ranging from 2.53 μg/mL to 12.65 μg/mL was determined in each well and incubated with bacteria for 20-24 hrs in LB broth. After incubation 10 μL of alamar blue dye was added to each well and incubated for 30 minutes before measuring the absorbance at 570 nm and 600 nm. The values were entered into an alamar blue reduction formula to obtain the percent reduction of alamar blue. The higher the reduction, the higher the bacterial growth/viability.

Alamar blue is a colorimetric/fluorometric dye which indicates cell viability. Reduction of the dye related to growth causes the change from oxidized (non-fluorescent, blue) form to reduced (fluorescent, red) form. FIG. 13 shows bacteria were completed killed at the concentrations of Quat materials between 2.53 μg/mL to 12.65 μg/mL. These results strongly support the feasibility of developing a non-Cu based biocide (i.e., microbicide/bactericide/fungicide) for long term protection against citrus canker and other afflictions.

### 4. Experimental Methods for Preparing Embodied Fixed-Quat Materials

### 4.1. Example 1

### Fixed-Quat Silica Nanoparticles

50 mL of Fixed-Quat Silica Nanoparticles

Ethanol (EtOH)=38 mL

Ammonium hydroxide (NH₄OH)=7.6 mL

Tetraethylorthosilicate (TEOS)=2.12 mL

Quat=2.28 mL

Quat active ingredients:
octyl decyl dimethyl ammonium chloride=6.510%
dioctyl dimethyl ammonium chloride=2.604%
didecyl dimethyl ammonium chloride=3.906%
alkyl (C14 50%, C12 40%, C16 10%) dimethyl benzyl ammonium chloride=8.680%).

Conc. hydrochloric acid (HCl)=4.1 mL

Ethanol and ammonium hydroxide were added together and set to stir, creating a basic environment. TEOS was added slowly to the basic solution while stirring. Under basic conditions, the TEOS will be hydrolyzed. Quat was added to the reaction mixture 1 min after the addition of TEOS and the mixture is left to stir for 1 hr. After 1 hr, the mixture was then neutralized using conc. HCl. After neutralization, the solution was then washed 3 times through centrifugation (10,000 rpm for 10 minutes) using deionized water and making the solution back up to 50 mL with DI water.

When shaken, the solution produced heavy amounts of foam. The foam could be extracted, dried and used as fixed-quat nanoparticles. The extracted foam may be used in a tobacco smoke filter. The transparent solution may be used for antimicrobial applications. Additional quat can be added to the solution to re-dissolve the foam, creating long lasting slow release fixed-quat silica nanoparticles.

### 4.2. Example 2

### Fixed-Quat Silane Silica Nanoparticles

20 mL of Fixed-Quat Silane Silica Nanoparticles

Ethanol (EtOH)=10 mL

Ammonium hydroxide (NH₄OH)=2 mL

Tetraethylorthosilicate (TEOS)=1 mL

Dimethyltetradecyl-3-trimethoxysilyl propyl ammonium chloride (DTD-3-TSPAC)=0.5 or 0.25 mL

De-ionized water (DI H₂O)=6.5 or 6.75 mL

Ethanol, ammonium hydroxide and water are added together and set to stir, creating a basic environment. TEOS was added slowly to the basic solution while stirring. Under basic conditions, the TEOS was be hydrolyzed. After 24 hrs of stirring, DTD-3-TSPAC was added to the reaction mixture and left to stir for another 24 hrs. After further stirring the solution was then washed 3-5 times through centrifugation (10,000 rpm for 10 minutes) using deionized water and making the solution back up to 20 mL with DI water.

### 4.3. Example 3

### Fixed-Quat Silica Nanogel 1.0

110 mL of quat-silica nanogel

DI water=110 mL

Tetraethylorthosilicate (TEOS)=800 μL

Quat=1.0 mL

Quat active ingredients:
octyl decyl dimethyl ammonium chloride=6.510%
dioctyl dimethyl ammonium chloride=2.604%
didecyl dimethyl ammonium chloride=3.906%
alkyl (C14 50%, C12 40%, C16 10%) dimethyl benzyl ammonium chloride=8.680%.

Conc. hydrochloric acid (HCl)=150 μL

1M Sodium hydroxide (NaOH)=990 μL

DI water was measured out and set to stir. Conc. HCl was added to the water, creating a strongly acidic environment (˜pH 1-2). While stirring, quat was added slowly. The pH of the solution increased due to the basic nature of quat but remained acidic (˜pH 3). TEOS was then added slowly to the stifling quat-water mixture. The acidic environment of the mixture hydrolyzed the TEOS. The solution was left to stir for 16-24 hours. After stifling, the pH of the solution was raised to 4 using 1M NaOH. The solution was transparent, non-phytotoxic on citrus and highly antimicrobial.

Alternatively, the pH of the solution was raised to 7-8 using 1M NaOH to ensure non-phytotoxic properties on all plant species. This solution was opaque, non-phytotoxic and highly antimicrobial.

### 4.4. Example 4

### Fixed-Quat Silica Nanogel 2.0

24.5 mL of fixed quat-silica nanogel

DI water=20 mL

Tetraethylorthosilicate (TEOS)=1.4 mL

Quat reagent (dimethyl didecyl ammonium chloride (DDAC) 80% Solution=0.35 mL

OR tetradecyl benzyl ammonium chloride (TDBAC) can also be used instead of DDAC.

Conc. hydrochloric acid (HCl)=200 μL

1M sodium hydroxide (NaOH)=2.55 mL

DI water was measured out and set to stir. Conc. HCl was added to the water, creating a strongly acidic environment (˜pH 1-2). While stirring, DDAC was added slowly. The pH of the solution increased due to the basic nature of DDAC but remained acidic (˜pH 3). TEOS was then added slowly to the stifling DDAC-water mixture. The acidic environment of the mixture hydrolyzed the TEOS. The solution was left to stir for 16-24 hrs. After stirring, the pH of the solution was raised to 7-8 using 1M NaOH.

The solution was milky white, non-phytotoxic and highly antimicrobial.

The solution is very concentrated and must be diluted down before use.

DDAC concentration=0.0101 g/mL or 10.1 mg/mL or 10,138 μg/mL.

DDAC has MIC values ranging from 8-40 μg/mL, thus this material can be heavily diluted and remain active.

### 4.5 Example 5

### Fixed-Quat Silica Nanogel—2.0 Large Scale Synthesis

4 Gallons (15140 mL) of fixed-quat silica nanogel

DI water=12360 mL

Tetraethylorthosilicate (TEOS)=865.1 mL

Quat reagent (dimethyl didecyl ammonium chloride (DDAC) 80% Solution=216.3 mL

OR tetradecyl benzyl ammonium chloride (TDBAC) can also be used instead of DDAC.

Conc. hydrochloric acid (HCl)=124 mL

1M sodium hydroxide (NaOH)=1575 mL

DI water was measured out and set to stir. Conc. HCl was added to the water, creating a strongly acidic environment (˜pH 1-2). While stirring, DDAC was added slowly. The pH of the solution increased due to the basic nature of DDAC but remained acidic (˜pH 3). TEOS was then added slowly to the stifling DDAC-water mixture. The acidic environment of the mixture hydrolyzed the TEOS. The solution was left to stir for 16-24 hrs. After stirring, the pH of the solution was raised to 7-8 using 1M NaOH.

The solution was milky white, non-phytotoxic and highly antimicrobial.

The solution was very concentrated and must be diluted down before use.

DDAC concentration=0.0101 g/mL or 10.1 mg/mL or 10,138 μg/mL.

DDAC has MIC values ranging from 2-40 μg/mL, thus this material can be heavily diluted and remain active.

### 5. Additional Application of Fixed-Quat Material in Accordance with Embodiments

In concert with example 1 above the embodiments contemplate use of fixed-quat SiNP as a tobacco smoke purification application that may specifically reduce carcinogenic components within tobacco smoke with at least a partial transparency with respect to a nicotine component.

To that end, an experiment was designed using two controls and one test. The experiment utilized conventional commercially available cigarettes, purchased at a local source. The cigarettes had been prepared by first removing the cellulose acetate filter, which was then unwrapped from the yellow paper surrounding it. The filter was then either left intact and placed in a holder, cut in half to yield two abutted cylinders and reassembled in a holder, or cut in half and reassembled with 10 mg of composite fixed-quat SiNP/NG nanomaterial interposed between the two cylinders within a holder. After assembly of this filter, a cigarette which had previously had its filter removed was also placed into the holder.

A baseline smoke removal rate was determined by assessing the change in weight of both the uncut filter and the filter which had been cut and reassembled with no addition of composite fixed-quat SiNP/NG nanomaterial. One cigarette was smoked through each trial filter using a vacuum pump, and the initial and final masses were compared in order to obtain the change in mass, representing the amount of smoke component captured. After establishing the average amount of smoke components in milligrams (mg) the two control filters capture, the cellulose acetate filter, which was cut in half and packed with 10 mg of the novel composite fixed-quat SiNP/NG nanomaterial was examined. One cigarette was smoked through using a vacuum pump, and the change in mass was calculated.

The data indicate that the addition of the fixed-quat SiNP/NG nanomaterial composite to the cut cellulose acetate filter was responsible for increased retention of smoke components within the filter. Although not illustrated herein images of a filter containing 10 mg of the composite fixed-quat SiNP/NG nanomaterial can be seen both before and after smoking of a cigarette. The retention of smoke components within the composite material is very easily seen as a dark ring between the two outer filter pieces. Furthermore, a difference in color, indicating the quantity of smoke components captured, between the upstream and downstream filter pieces can be observed.

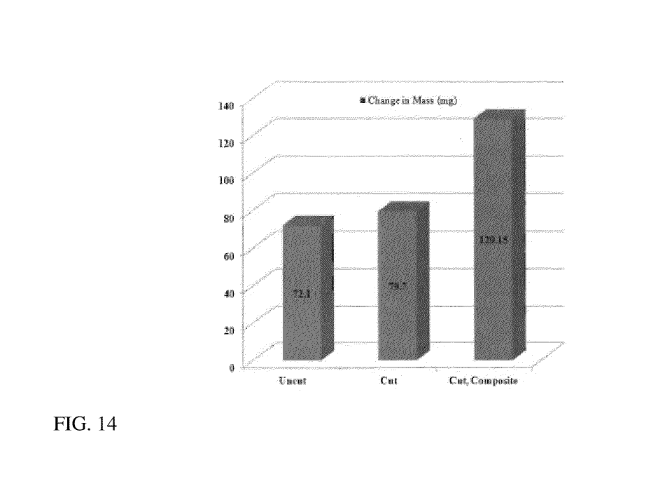

FIG. 14 shows a graphical representation of the data collected. Sample size was n=4 for each type of filter, and the average change in mass was calculated using a simple average. During testing, it was observed that the composite fixed-quat SiNP/NC nanomaterial was capable of reducing the amount of smoke passing through the filter, but the presence of the nanomaterial did not prevent smoke from exiting the other end of the filter. Future analysis of both the smoke flow through and the compounds captured by the nanomaterial will assess the ratio of removal of the undesirable components of smoke to nicotine.

While the foregoing experiment was executed specifically with respect to tobacco smoke the embodiments are not intended to be so limited. Rather, the embodiments contemplate an ability to selectively filter in general aerosol components from alternative multicomponent aerosols as a function of a chemical structure of a fixed-quat portion of a fixed-quat SiNP/NC nanomaterial. As is understood by a person skilled in the art, hydrophilic fixed-quat compositions would be expected to be preferentially selective to hydrophilic aerosol or smoke components and hydrophobic fixed-quat compositions would be expected to be preferentially selective to hydrophobic aerosol or smoke components.

All references, including publications, patent applications, and patents cited herein are hereby incorporated by reference in their entireties to the extent allowed, and as if each reference was individually and specifically indicated to be incorporated by reference and was set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening.

The recitation of ranges of values herein is merely intended to serve as a shorthand method of referring individually to each separate value falling within the range, unless otherwise indicated herein, and each separate value is incorporated into the specification as if it was individually recited herein.

All methods described herein may be performed in any suitable order unless otherwise indicated herein or otherwise clearly contradicted by context. The use of any and all examples, or exemplary language (e.g., “such as”) provided herein, is intended merely to better illuminate embodiments of the invention and does not impose a limitation on the scope of the invention unless otherwise claimed.

No language in the specification should be construed as indicating any non-claimed element as essential to the practice of the invention.

It will be apparent to those skilled in the art that various modifications and variations can be made to the present invention without departing from the spirit and scope of the invention. There is no intention to limit the invention to the specific form or forms disclosed, but on the contrary, the intention is to cover all modifications, alternative constructions, and equivalents falling within the spirit and scope of the invention, as defined in the appended claims. Thus, it is intended that the present invention cover the modifications and variations of this invention provided they come within the scope of the appended claims and their equivalents.

What is claimed is:

1. A nanomaterial comprising a nanoparticle comprising a metal oxide immobilized quaternary ammonium material.

2. The nanomaterial of claim 1 wherein the metal oxide immobilized quaternary ammonium material comprises:
a hydrophilic metal oxide core;
a charge neutralization layer surrounding the hydrophilic metal oxide core; and
a hydrophobic shell surrounding the charge neutralization layer.

3. The nanomaterial of claim 2 wherein the charge neutralization layer comprises a hydroxyl ion and quaternary ammonium ion charge neutralization layer.

4. The nanomaterial of claim 1 wherein the nanomaterial is characterized by a complete shift of at least one spectroscopic resonance of the quaternary ammonium material from an unbound quaternary ammonium material resonance to a metal oxide immobilized quaternary ammonium material resonance.

5. The nanomaterial of claim 4 wherein the spectroscopic resonance comprises an infrared spectroscopic resonance.

6. The nanomaterial of claim 1 wherein the nanoparticle has a diameter from about 10 to about 500 nanometers.

7. The nanomaterial of claim 1 wherein the metal oxide comprises silicon oxide.

8. The nanomaterial of claim 1 wherein the metal oxide is selected from the group consisting of silicon, titanium, aluminum, zinc and cerium metal oxides.

9. The nanomaterial of claim 1 wherein the quaternary ammonium material includes pendant groups independently selected from the group consisting of a hydrogen radical, a C1 to C20 alkyl radical, a C1 to C20 alkenyl radical, a C1 to C20 alkynyl radical and an aromatic radical.

10. A method for preparing a nanomaterial comprising hydrolyzing a metal oxide precursor material within the presence of a quaternary ammonium material to provide a nanoparticle comprising a metal oxide immobilized quaternary ammonium material.

11. The method of claim 10 wherein the hydrolyzing uses a basic hydrolysis.

12. The method of claim 10 wherein the hydrolyzing uses an acidic hydrolysis.

13. The method of claim 10 wherein the metal oxide immobilized quaternary ammonium material comprises:
a hydrophilic metal oxide core;
a charge neutralization layer surrounding the hydrophilic metal oxide core; and
a hydrophobic shell surrounding the charge neutralization layer.

14. The method of claim 10 wherein the nanomaterial is characterized by a complete shift of at least one spectroscopic resonance of the quaternary ammonium material from an unbound quaternary ammonium material resonance to a metal oxide immobilized quaternary ammonium material resonance.

15. A biocide comprising:
a nanomaterial comprising a nanoparticle comprising a metal oxide immobilized quaternary ammonium material; and
a carrier fluid.

16. The biocide of claim 15 wherein the metal oxide immobilized quaternary ammonium material comprises:
a hydrophilic metal oxide core;
a charge neutralization layer surrounding the hydrophilic metal oxide core; and
a hydrophobic shell surrounding the charge neutralization layer.

17. The biocide of claim 15 wherein the nanomaterial is characterized by a complete shift of at least one spectroscopic resonance of the quaternary ammonium material from an unbound quaternary ammonium material resonance to a metal oxide immobilized quaternary ammonium material resonance.

18. An agricultural method comprising treating with a nanoparticle based biocide comprising a metal oxide immobilized quaternary ammonium material an agricultural crop susceptible to a bacterial infection.

19. The method of claim 18 wherein the metal oxide immobilized quaternary ammonium material comprises:
a hydrophilic metal oxide core;
a charge neutralization layer surrounding the hydrophilic metal oxide core; and
a hydrophobic shell surrounding the charge neutralization layer.

20. The method of claim 18 wherein the nanomaterial is characterized by a complete shift of at least one spectroscopic resonance of the quaternary ammonium material from an unbound quaternary ammonium material resonance to a metal oxide immobilized quaternary ammonium material resonance.

21. A filter medium comprising a nanomaterial comprising a nanoparticle comprising a metal oxide immobilized quaternary ammonium material.

22. The filter of claim 21 wherein the metal oxide immobilized quaternary ammonium material comprises:
a hydrophilic metal oxide core;
a charge neutralization layer surrounding the hydrophilic metal oxide core; and
a hydrophobic shell surrounding the charge neutralization layer.

23. The filter of claim 21 wherein the nanomaterial is characterized by a complete shift of at least one spectroscopic resonance of the quaternary ammonium material from an unbound quaternary ammonium material resonance to a metal oxide immobilized quaternary ammonium material resonance.

24. A filtration method comprising filtering with a nanoparticle based filtration medium comprising a metal oxide immobilized quaternary ammonium material an aerosol stream to preferentially capture from the aerosol stream a first aerosol component with respect to a second aerosol component different from the first aerosol component.

25. The method of claim 24 wherein the metal oxide immobilized quaternary ammonium material comprises:
a hydrophilic metal oxide core;
a charge neutralization layer surrounding the hydrophilic metal oxide core; and
a hydrophobic shell surrounding the charge neutralization layer.

26. The method of claim 24 wherein the nanomaterial is characterized by a complete shift of at least one spectroscopic resonance of the quaternary ammonium material from an unbound quaternary ammonium material resonance to a metal oxide immobilized quaternary ammonium material resonance.
